(19) United States
(12) Patent Application Publication
(10) Pub. No.: US 2007/0074102 A1
(43) Pub. Date: Mar. 29, 2007

(54) Automatically determining topical regions in a document

(76) Inventors: Reiner Kraft, Gilroy, CA (US); Farzin Maghoul, Hayward, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/239,729

(22) Filed: Sep. 29, 2005

(51) Int. Cl. G06F 17/00; G06F 17/30; G06F 3/00

(52) U.S. Cl. 715/512; 707/3; 715/764; 715/530

(57) ABSTRACT

Techniques for automatically adding context-sensitive search-enabling user interface elements to a web page are provided. According to one technique, topical regions of a document are automatically determined by computer-implemented means. The document is automatically separated into topically different sections. For each section, at least some of the topics to which that section pertains are automatically determined. Between each of the sections, a user interface element is automatically inserted into the document. Each such user interface element is automatically associated with the topics to which the section immediately preceding that user interface element pertains. A user's subsequent activation of such a user interface element causes context-sensitive search results to be provided to the user. The context-sensitive search results are focused specifically on web pages that pertain to the topics with which the activated user interface element is associated, and substantially exclude web pages that do not pertain to those topics.

### FIELD OF THE INVENTION

The present invention relates to data processing and, more specifically, to determining topical regions of a document automatically.

### BACKGROUND

Search engines that enable computer users to obtain references to web pages that contain one or more specified words are now commonplace. Typically, a user can access a search engine by directing a web-browser to a search engine “portal” web page. The portal page usually contains a text entry field and a button control. The user can initiate a search for web pages that contain specified query terms by typing those query terms into the text entry field and then activating the button control. When the button control is activated, the query terms are sent to the search engine, which typically returns, to the user's web browser, a dynamically generated web page that contains a list of references to other web pages that contain the query terms.

One drawback of using a search engine in this manner emerges from the context-insensitive manner in which search results are determined. Often, while a user is reading content from a “source” web page, he may come across a topic about which he would like to obtain additional information. His curiosity piqued, the user might then direct his web browser to the portal page and submit, as query terms, words that he read in the “source” page-words that the user associates, in his mind, with the topic of interest. Hopefully, the results that the search engine returns include at least some references to web pages that pertain to the topic. Unfortunately, the results also may include a plethora of references to other web pages that contain the query terms, but have little or nothing to do with the topic.

For example, a user might be reading a “source” page that contains an article about a familiar computer-related business whose name happens to be the same as that of a fruit. After submitting the name of the business to a search engine as a query term, the user may be disappointed to discover that the vast majority of the results returned by the search engine are references to web pages that pertain to the fruit rather than the business. The user is then faced with the options of prospecting through numerous pages of irrelevant references for a few elusive relevant references, trying to refine the query terms so that future search results will exclude irrelevant references but not relevant references, or abandoning the search entirely.

U.S. patent application Ser. No. 10/903,283, filed on Jul. 29, 2004, discloses techniques for performing context-sensitive searches. According to one such technique, a “source” web page may be enhanced with user interface elements that, when activated, cause a search engine to provide search results that are directed to a particular topic to which at least a portion of the “source” web page pertains. For example, such user interface elements may be “Y!Q” elements, which now appear in many web pages all over the Internet. For additional information on “Y!Q” elements, the reader is encouraged to submit “Y!Q” as a query term to a search engine.

A web page author may enhance his web page by modifying his web page to include such user interface elements. To do so, first the author determines topics to which his web page pertains. Different sections of a web page may pertain to different topics. Once the author has decided the topics to which his web page pertains, the author manually modifies the source code of his web page so that the source code contains references to the user interface elements discussed above. In the source code, the author specifies both the location of each user interface element and the topics that are associated with each user interface element. After the source code has been modified in this manner, the user interface elements will appear on the web page.

Searches conducted via such a user interface element take into account the topics that the author has associated with that user interface element. Results produced by such searches focus on web pages that specifically pertain to those topics, making those results context-specific.

Although the addition of such user interface elements can greatly enhance the usefulness of a web page, the task of modifying a web page's source code can be an onerous one. Some of the more amateur web page authors may be reluctant to attempt to modify the source code of their web pages, which they might have initially created with the assistance of a computer program. If a web site comprises numerous web pages, then the burden placed on the person who modifies the web pages increases. Under previous approaches, when adding such user interface elements to a web page, a human being had to ponder carefully the topics that he should associate with each user interface element, and also the locations in the web page at which such user interface elements should be placed.

To the detriment of web surfers everywhere, these burdens may discourage the rapid and widespread adoption of the context-sensitive search-enabling user interface elements discussed above.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates an example of a technique for determining topically different document sections based on document portion similarity measurements, according to an embodiment of the invention;

FIG. 2 is a flow diagram that illustrates an example of a technique for determining topically different document sections based on concept co-occurrence, according to an embodiment of the invention; and

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to one embodiment of the invention, topical regions of a document, such as a web page, are automatically determined by computer-implemented means. The document is automatically and logically divided into topically different sections. For each section, at least some of the topics to which that section pertains are automatically determined. Between each of the sections, a user interface element is automatically inserted into the document. Each such user interface element is automatically associated with the automatically determined topics to which the section immediately preceding the user interface element pertains. A user's subsequent activation of such a user interface element causes context-sensitive search results to be provided to the user. The context-sensitive search results are focused specifically on references to web pages that pertain to the topics with which the activated user interface element was automatically associated, and substantially exclude references to web pages that do not pertain to those topics.

For example, according to one embodiment of the invention, a computer program automatically and logically divides a web page into topically different sections. The computer program might determine that the first three paragraphs of a web page pertain to a first topic, and that the remaining two paragraphs of the web page pertain to a second topic, for example. Under such circumstances, the computer program might insert, between the third and fourth paragraphs, a first user interface element that is associated with the first topic. After the fifth paragraph, the computer program might insert a second user interface element that is associated with the second topic. The computer program may perform the preceding process without any involvement or direction from a human being.

Each user interface element may be, for example, a context-sensitive search-enabling element of the kind that is disclosed in U.S. patent application Ser. No. 10/903,283, titled “SEARCH SYSTEMS AND METHODS USING IN-LINE CONTEXTUAL QUERIES,” the contents of which patent application are incorporated by reference in their entirety for all purposes, as though originally disclosed herein.

Continuing the above example, a user subsequently viewing the automatically enhanced web page might activate the first user element. In response to the activation, the user's web browser might request query terms from the user, suggest some query terms, or automatically supply some query terms. With query terms determined, the user's web browser may send both the query terms and the first topic, which is associated with the first user element, to a search engine. The search engine may responsively generate search results that substantially consist of references to web pages that contain the query terms specifically in the context of the first topic, and provide those search results to the user.

Examples of various techniques for automatically and logically dividing a document into topically different sections, and techniques for automatically determining the topics to which those sections pertain, are described in greater detail below.

### Determining Dissimilar Document Sections

According to one embodiment of the invention, topically different sections are automatically determined by comparing the contents of different portions of the document to each other. If the contents of the different portions are dissimilar enough, then the portions are deemed to be topically different sections, and a separate context-sensitive search-enabling user interface element is inserted into the document immediately after one or more of the sections.

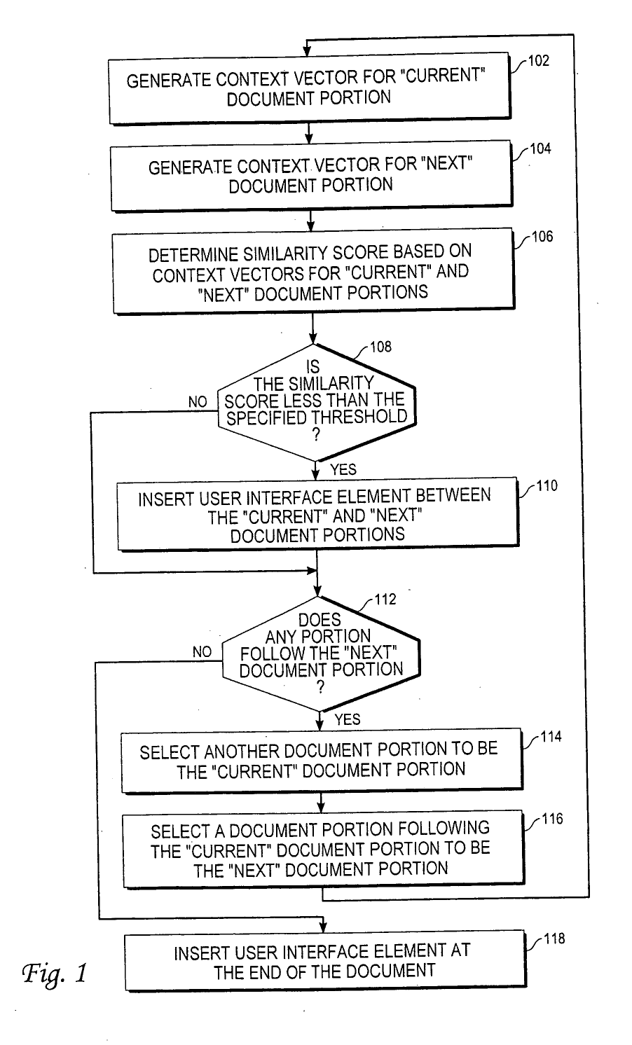

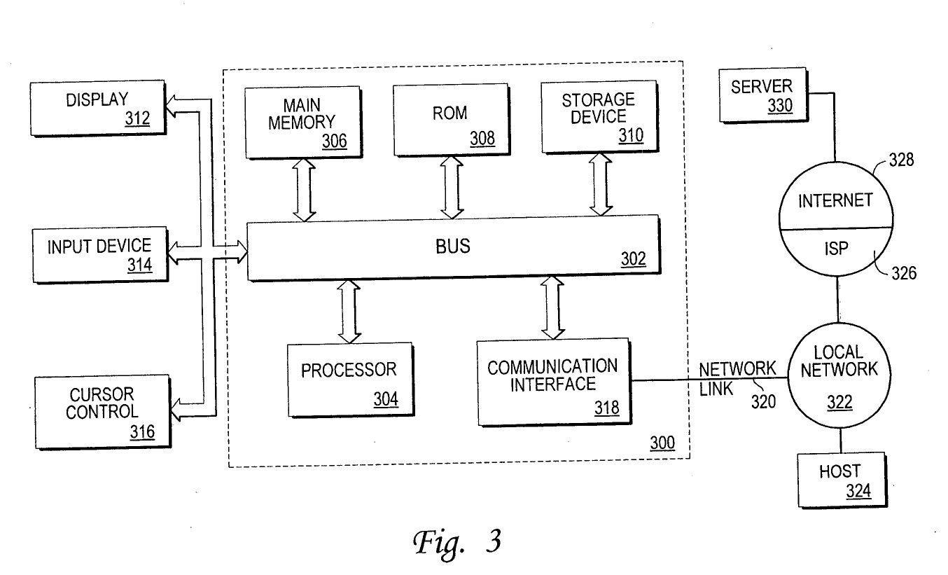

FIG. 1 is a flow diagram that illustrates an example of a technique for determining topically different document sections based on document portion similarity measurements, according to an embodiment of the invention. The technique may be performed by a process executing on a computer such as the computer described below with reference to FIG. 3, for example.

In block 102, a context vector is generated for the “current” portion of a document. For example, the “current” portion of the document initially may be a first portion of the document, such as the first paragraph or the first “N” words of the document, where “N” is a specified number.

The context vector generated for a document portion generally describes characteristics of the contents of that portion. In one sense, the context vector generated for a document portion indicates the topics to which that document portion pertains. For example, a context vector may identify significant words and/or phrases in the document portion, and/or the number of times that those words and/or phrases occur in the document portion. A technique for generating a context vector for a body of text is disclosed in U.S. patent application Ser. No. 10/903,283, referred to above.

In block 104, a context vector is generated for the “next” portion of the document. The “next” portion of the document is the portion that immediately follows the “current” portion of the document. For example, the “next” portion may be the next paragraph or the next “N” words of the document following the “current” portion.

In block 106, a similarity score is determined by comparing the context vector of the “current” portion with the context vector of the “next” portion. The more similar the context vectors of the document portions, the higher the similarity score will be. Numerous different techniques may be used to determine the similarities between two context vectors. For example, the similarity score may be based on how may words and/or phrases occur in both of the document portions, as reflected by the context vectors of each. The well known cosine similarity algorithm may be used to compute the similarity score, for example.

In block 108, it is determined whether the similarity score is less than a specified threshold. If the similarity score is less than the specified threshold, meaning that the document portions and the topics to which they pertain are not significantly similar, then control passes to block 110. Otherwise, control passes to block 112.

In block 110, a context-sensitive search-enabling user interface element is inserted into the document immediately after the “current” portion and immediately before the “next” portion. Insertion into a Hypertext Markup Language (HTML) document may be accomplished by modifying the source code of the document, for example. The boundaries of two topically different sections are deemed to lie between the “current” portion and the “next” portion of the document. The user interface element is associated with the topics to which the “current” portion pertains, as indicated by the context vector generated for the “current” portion in block 102. Thus, whenever a search is initiated via the user interface element, the associated topics will be submitted to the search engine along with any supplied query terms, and the search engine will return results that pertain to the associated topics, as described in U.S. patent application Ser. No. 10/903,283, referred to above. According to one embodiment of the invention, the user interface element is a well known “Y!Q” element.

In block 112, it is determined whether the document contains any portion that follows the “next” portion. If the document does contain such a portion, then control passes to block 114. Otherwise, control passes to block to block 118.

In block 114, another portion of the document is selected to be the new “current” portion. For example, the “next” portion of the document may be selected as the new “current” portion. For another, alternative example, a portion of the document beginning at an offset of “X” words or sentences after the beginning of the “current” portion may be selected as the new “current” portion; the ‘N’ words beginning at this offset may be selected, for example. Thus, in one embodiment of the invention, the new “current” portion may overlap with the previous “current” portion.

In block 116, a portion of the document following the new “current” portion is selected to be the new “next” portion. For example, the new “next” portion may be the next paragraph or the next “N” words of the document following the new “current” portion. Control passes back to block 102.

Alternatively, in block 118, the end of the document has been reached. A context-sensitive search-enabling user interface element is inserted at the end of the document. The user interface element is associated with the topics to which the “next” portion pertains, as indicated by the context vector generated for the “next” portion in block 104. According to one embodiment of the invention, the user interface element is a well known “Y!Q” element.

### Determining Section Boundaries Based on Concept Co-Occurrence

The technique described above can sometimes divide a topically coherent region of text into separate topical sections. For example, a given paragraph may pertain to multiple diverse topics, and yet all of the topics may be interrelated. Under such circumstances, the application of the technique described above might cause a user interface element to be inserted into the middle of the paragraph. Where a body of text pertains to multiple interrelated concepts, it is often better to maintain that body of text undivided by a user interface element, and, instead, insert a user interface element after that body of text. Such a user interface element may be associated with multiple topics.

As used herein, the term “concept” refers to one or more words. A concept may be a single word or a phrase that comprises multiple words whose meaning depends on the combination of those words.

In order to avoid the division of a coherent multi-topical region by user interface elements where the topics in that region are interrelated, an alternative embodiment of the invention, which determines document section boundaries based on the co-occurrences of concepts within other documents in a search corpus of documents, is described below.

Typically, a search engine operates in conjunction with a web crawling mechanism which discovers web pages on the Internet by following links on web pages that the web crawling mechanism has previously discovered. When the web crawling mechanism discovers a new web page that the mechanism had not hitherto discovered, the mechanism adds that web page to a search corpus. The search corpus comprises all of the content that the search engine examines when looking for documents that satisfy submitted query terms.

Two different concepts “co-occur” in a document when both of those concepts appear in the same document. If the search corpus contains many documents in which two different concepts co-occur, then those two concepts have a high “co-occurrence” relative to each other. Conversely, if the search corpus contains few or no documents in which two different concepts co-occur, then those two concepts have a low “co-occurrence” relative to each other. The “co-occurrence” of two different concepts is indicative of how topically related those concepts are. The technique described below takes advantage of co-occurrence measurements in order to determine document section boundaries. However, the determination of the co-occurrence measurements of various concept pairs may be determined separately from (e.g., prior to) the performance of the technique described below.

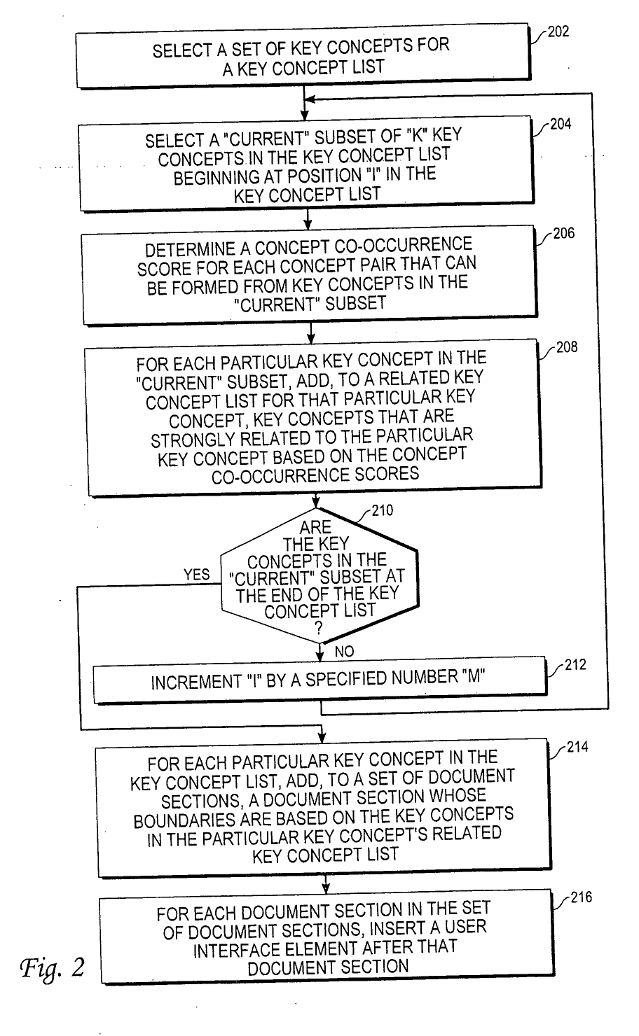

FIG. 2 is a flow diagram that illustrates an example of a technique for determining topically different document sections based on concept co-occurrence, according to an embodiment of the invention. The technique may be performed by a process executing on a computer such as the computer described below with reference to FIG. 3, for example.

In block 202, a set of key concepts that occur in a target document are selected. The target document is the document into which the context-sensitive search-enabling user interface elements are to be inserted. Typically, the set of key concepts will comprise fewer than all of the words in the target document, and will comprise those concepts which are topically representative of portions of the document.

A variety of techniques may be used to select key concepts. For example, key concepts may be identified based on concept networks, as is described in U.S. patent application Ser. No. 10/713,576, titled “SYSTEMS AND METHODS FOR GENERATING CONCEPT NETWORKS FROM USER QUERIES,” and U.S. patent application Ser. No. 10/797,614, titled “SYSTEMS AND METHODS FOR PROCESSING USING SUPERUNITS,” the contents of which patent applications are incorporated by reference in their entirety for all purposes, as though originally disclosed herein. Concept networks generally indicate relationships between concepts. Each concept in the document that is strongly related to other concepts in the document, as indicated by a concept network, may be selected as a key concept, for example. However, embodiments of the invention are not limited to any particular technique for selecting key concepts.

For example, a portion of an example target document might read as follows:

“LOS ANGELES, Calif. (Reuters) Sony Corp.'s new PlayStation Portable is turning into a great tool for web browsing, comics, reading, and online chat and it also happens to play video games, movies, and music, if your prefer that sort of thing.”

“The $249 PSP handheld video game player went on sale in the United States on March 24, and it took very little time before techies added the kinds of functions to the PSP that Sony did not include—and may never have intended. One man needed only 24 hours to get a working client for Internet Relay Chat, or IRC, an older messaging platform.”

In the above portion, the following key concepts might be some of those identified: Los Angeles, Angeles, Calif., Sony Corp, PlayStation Portable, tool, web browsing, comics, reading, online chat, play video, video games, play video games, movies, music, etc. The key concepts may be inserted into a key concept list that is ordered based on the location of the key concepts in the target document.

In block 204, a “current” subset of the key concepts is selected from the key concept list determined in block 202. In one embodiment of the invention, the “current” subset comprises (a) the “I^{th}” key concept in the ordered key concept list, where “I” is initially equal to 1, and (b) the “K” key concepts that follow the “I^{th}” key concept in the ordered key concept list, where “K” is a specified number.

In block 206, for each distinct concept pair that can be formed by combining key concepts in the subset selected in block 204, a concept co-occurrence score is determined for that concept pair. As is discussed above, the concept co-occurrence score for a concept pair generally indicates the extent to which the concepts in that concept pair occur in the same documents in a specified set of documents (e.g., the search corpus). A variety of techniques can be used to compute the concept co-occurrence scores, and embodiments of the invention are not limited to any particular technique.

For example, the concept pair [“PlayStation Portable,” “play video games”] might be associated with a concept co-occurrence score of 0.2500. The concept pair [“PlayStation Portable,” “Sony-Corp”] might be associated with a concept co-occurrence score of 0.2987. Other concept pairs might be associated with other concept co-occurrence scores.

In block 208, for each particular key concept in the subset of key concepts selected in block 204, other key concepts that are strongly related to that key concept are added to a list of related key concepts associated with the particular key concept. For example, a list of related key concepts for a particular key concept may be updated by (a) selecting, from among the concept pairs determined in block 206, all of the concept pairs that are associated with a co-occurrence score that is greater than a specified threshold (the “high co-occurrence concept pairs”), and (b) adding, to the list of related key concepts, all of the concepts that occur with the particular key concept in any selected high co-occurrence concept pair.

For example, if the key concepts “Angeles” and “California” highly co-occur with the key concept “Los Angeles,” then the list of related key concepts for “Los Angeles” will include “Angeles” and “California.” For another example, if the key concepts “PlayStation Portable” and “web browsing” highly co-occur with the key concept “Sony Corp,” then the list of related key concepts for “Sony Corp” will include “PlayStation Portable” and “web browsing.”

Initially, each key concept's associated list of related key concepts is empty. With each iteration of block 208, each list of related key concepts may expand to include additional related key concepts.

In block 210, it is determined whether the “current” subset of the key concepts selected in block 204 is at the end of the ordered key concept list determined in block 202. If the “current” subset of the key concepts is at the end of the ordered key concept list, then control passes to block 214. Otherwise, control passes to block 212.

In block 212, the variable “I,” discussed above with reference to block 204, is incremented by a specified number “M.” Control then passes back to block 204, in which a new “current” subset of key concepts is selected from among the list of all of the key concepts. Thus, the “current” subset of key concepts may be viewed as a “sliding window” of “K” key concepts within the overall ordered key concept list.

Alternatively, in block 214, all of the related key concept lists for all of the key concepts in the target document have been finalized. For each particular key concept determined in block 202, a section of the target document that comprises (a) at least one instance of the particular key concept and (b) at least one instance of each of the other key concepts in the particular key concept's associated related key concept list is determined. This document section determined is added to a set of document sections. Each document section has a starting and ending boundary in the target document.

For example, the smallest and first-occurring section of the target document that contains all of these key concepts may be determined. Other techniques for determining the section may be used instead. Embodiments of the invention are not limited to any particular technique for determining the selection.

For example, if the particular key concept is “Sony Corp” and the particular key concept's associated related key concept list comprises key concepts “PlayStation Portable” and “web browsing,” then the section of the target document selected might be “Sony Corp.'s new PlayStation Portable is turning into a great tool for web browsing.” The section contains at least one instance each of the related key concepts “Sony Corp,” “PlayStation Portable,” and “web browsing.”

In block 216, for each particular document section in the set of document sections determined in block 214, a context-sensitive search-enabling user interface element is inserted into the document after the ending boundary of the particular document section. The user interface element is associated with the topics to which the particular document section pertains, as may be indicated by a context vector generated for the particular document section. Thus, whenever a search is initiated via the user interface element, the associated topics will be submitted to the search engine along with any supplied query terms, and the search engine will return results that pertain to the associated topics, as described in U.S. patent application Ser. No. 10/903,283, referred to above. According to one embodiment of the invention, the user interface element is a well known “Y!Q” element.

In one embodiment of the invention, the key concepts that are contained in a particular document section also may be associated, as suggested query terms, with the user interface element that is inserted after that particular document section. Thus, when a search is initiated via the user interface element, the key concepts may be automatically submitted to the search engine as query terms. The key concepts in the target document may be visually highlighted to inform users about what those key concepts are.

### Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method of automatically annotating a document, the method comprising:
automatically determining that a first section of the document pertains to a set of one or more topics;
automatically determining that a second section of the document does not pertain to the set as much as does the first section;
automatically determining boundaries of the first section; and
inserting, into the document, at a location that is based at least in part on the boundaries, a user interface element that enables a user to obtain information about other documents associated with at least one of the topics.

2. The method of claim 1, wherein the user interface element enables the user to obtain a list of references to the other documents.

3. The method of claim 1, further comprising:
automatically determining one or more words that are in the first section;
wherein each of the other documents contains at least one of the one or more words.

4. The method of claim 1, wherein the steps of automatically determining that the first section pertains to the set and automatically determining that the second section of the document does not pertain to the set as much as does the first section comprise:
determining an extent to which the first section is similar to the second section.

5. The method of claim 4, wherein the steps of automatically determining that the first section pertains to the set and automatically determining that the second section of the document does not pertain to the set as much as does the first section comprise:
determining whether a similarity measurement, which indicates the extent to which the first section is similar to the second section, is less than a specified threshold.

6. The method of claim 1, wherein the steps of automatically determining that the first section pertains to the set and automatically determining that the second section of the document does not pertain to the set as much as does the first section comprise:
determining a plurality of key concepts in the document;
generating a plurality of concept pairs based at least in part on the plurality of key concepts;
determining a separate score for each concept pair in the plurality of concept pairs; and
selecting, from among the plurality of concept pairs, a set of selected concept pairs that are each associated with a score that is above a specified threshold.

7. The method of claim 6, wherein the step of automatically determining boundaries of the first section comprises:
determining the boundaries based at least in part on locations, in the document, of concepts belonging to a concept pair of the selected concept pairs.

8. The method of claim 6, wherein the step of determining a separate score for each concept pair in the plurality of concept pairs comprises:
determining, for a particular concept pair in the plurality of concept pairs, how many documents within a specified plurality of documents contain both concepts in the particular concept pair;
wherein the score for the particular concept pair is based at least in part on how many documents within the specified plurality of documents contain both concepts in the particular concept pair.

9. A computer-implemented method of automatically annotating a document, the method comprising:
automatically determining a first extent to which a first section of the document is similar to a second section of the document;
automatically determining whether the first extent is less than a specified threshold; and
if the first extent is less than the specified threshold, then inserting, into the document, between the first section and the second section, a user interface element that enables a user to obtain information about other documents associated with at least one topic to which the first section pertains.

10. The method of claim 9, further comprising:
if the first extent is not less than the specified threshold, then, without inserting the user interface element between the first section and the second section, performing steps comprising:
automatically determining a second extent to which the second section of the document is similar to a third section of the document;
automatically determining whether the second extent is less than the specified threshold; and
if the second extent is less than the specified threshold, then inserting, into the document, between the second section and the third section, a user interface element that enables a user to obtain information about other documents associated with at least one topic to which the second section pertains.

11. A computer-implemented method of automatically annotating a document, the method comprising:
determining a plurality of key concepts in the document;
generating a plurality of concept pairs based at least in part on the plurality of key concepts;
determining a separate score for each concept pair in the plurality of concept pairs;
selecting, from among the plurality of concept pairs, a set of selected concept pairs that are each associated with a score that is above a specified threshold;
for each particular concept that occurs in a selected concept pair, performing steps comprising:
generating a concept list that contains other concepts that occur in selected concept pairs with the particular concept;
determining a document subsection that contains (a) the particular concept and (b) each concept in the concept list generated for the particular concept; and
inserting, into the document, at a location that is based at least in part on where the document subsection ends, a user interface element that enables a user to obtain information about other documents associated with at least one topic to which the document subsection pertains.

12. The method of claim 11, wherein the step of determining a separate score for each concept pair in the plurality of concept pairs comprises:
determining, for a particular concept pair in the plurality of concept pairs, how many documents within a specified plurality of documents contain both concepts in the particular concept pair;
wherein the score for the particular concept pair is based at least in part on how many documents within the specified plurality of documents contain both concepts in the particular concept pair.

13. A computer-readable medium carrying one or more sequences of instructions which, when executed by one or more processors, causes the one or more processors to perform the method recited in claim 1.

14. A computer-readable medium carrying one or more sequences of instructions which, when executed by one or more processors, causes the one or more processors to perform the method recited in claim 2.

15. A computer-readable medium carrying one or more sequences of instructions which, when executed by one or more processors, causes the one or more processors to perform the method recited in claim 3.

16. A computer-readable medium carrying one or more sequences of instructions which, when executed by one or more processors, causes the one or more processors to perform the method recited in claim 4.

17. A computer-readable medium carrying one or more sequences of instructions which, when executed by one or more processors, causes the one or more processors to perform the method recited in claim 5.

18. A computer-readable medium carrying one or more sequences of instructions which, when executed by one or more processors, causes the one or more processors to perform the method recited in claim 6.

19. A computer-readable medium carrying one or more sequences of instructions which, when executed by one or more processors, causes the one or more processors to perform the method recited in claim 7.

20. A computer-readable medium carrying one or more sequences of instructions which, when executed by one or more processors, causes the one or more processors to perform the method recited in claim 8.

21. A computer-readable medium carrying one or more sequences of instructions which, when executed by one or more processors, causes the one or more processors to perform the method recited in claim 9.

22. A computer-readable medium carrying one or more sequences of instructions which, when executed by one or more processors, causes the one or more processors to perform the method recited in claim 10.

23. A computer-readable medium carrying one or more sequences of instructions which, when executed by one or more processors, causes the one or more processors to perform the method recited in claim 11.

24. A computer-readable medium carrying one or more sequences of instructions which, when executed by one or more processors, causes the one or more processors to perform the method recited in claim 12.
